(19) United States
(12) Patent Application Publication
(10) Pub. No.: US 2026/0126849 A1
(43) Pub. Date: May 7, 2026

(54) TRACKING METHOD, MULTI-DEVICE SYSTEM AND NON-TRANSITORY COMPUTER READABLE STORAGE MEDIUM

(71) Applicant: HTC Corporation, Taoyuan City (TW)

(72) Inventors: Chun-Kai HUANG, Taoyuan City (TW); Chih Chien CHEN, Taoyuan City (TW)

(21) Appl. No.: 18/935,635

(22) Filed: Nov. 3, 2024

(51) Int. Cl. G06F 3/01; G06F 1/16

(52) U.S. Cl. CPC G06F 3/011; G06F 3/0346; G06T 7/70; G06T 7/20

(57) ABSTRACT

The present disclosure provides a tracking method and a multi-device system. The multi-device system is used to track a target object in a physical environment and includes a host device and a peripheral device. The tracking method includes: by the peripheral device, tracking the peripheral device; when the host device determines to track the target object, by the host device, tracking the peripheral device, to generate a first spatial relationship between the peripheral device and the host device; and by the peripheral device, tracking the target object according to the first spatial relationship, to generate a second spatial relationship between the target object and the host device.

### BACKGROUND

### Field of Invention

This disclosure relates to a method and a system, in particular to a tracking method and a multi-device system.

### Description of Related Art

Some related arts allow an operable electronic device (e.g., a handheld controller, a wearable controller, etc.) to perform multiple applications (e.g., a self-tracking, an object tracking, etc.) through a computing chip with a high performance. However, if one application requires a high chip computing power, the electronic device cannot perform other applications at the same time, which limit the range of application.

### SUMMARY

An aspect of present disclosure relates to a tracking method applicable to a multi-device system. The multi-device system is configured to track a target object in a physical environment and includes a host device and a peripheral device. The tracking method includes: by the peripheral device, tracking the peripheral device; when the host device determines to track the target object, by the host device, tracking the peripheral device, to generate a first spatial relationship between the peripheral device and the host device; and by the peripheral device, tracking the target object according to the first spatial relationship, to generate a second spatial relationship between the target object and the host device.

Another aspect of present disclosure relates to a multi-device system. The multi-device system is configured to track a target object in a physical environment and includes a host device and a peripheral device. The host device is configured to determine whether to track the target object or not. The peripheral device is configured to track the peripheral device. The host device is configured to track the peripheral device when the host device determines to track the target object, to generate a first spatial relationship between the peripheral device and the host device. The peripheral device is configured to track the target object according to the first spatial relationship when the host device determines to track the target object, to generate a second spatial relationship between the target object and the host device.

Another aspect of present disclosure relates to a non-transitory computer readable storage medium with a computer program to execute a tracking method applicable to a multi-device system. The multi-device system is configured to track a target object in a physical environment and includes a host device and a peripheral device. The tracking method includes: by the peripheral device, tracking the peripheral device; when the host device determines to track the target object, by the host device, tracking the peripheral device, to generate a first spatial relationship between the peripheral device and the host device; and by the peripheral device, tracking the target object according to the first spatial relationship, to generate a second spatial relationship between the target object and the host device.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a multi-device system in accordance with some embodiments of the present disclosure;

FIG. 2 is a schematic diagram of the multi-device system tracking a target object in accordance with some embodiments of the present disclosure;

FIG. 3 is a flow diagram of a tracking method in accordance with some embodiments of the present disclosure;

FIG. 4 is a flow diagram of one operation of the tracking method in accordance with some embodiments of the present disclosure;

FIG. 5 is a flow diagram of one operation of the tracking method in accordance with some embodiments of the present disclosure;

FIG. 6 is a block diagram of a peripheral device of the multi-device system in accordance with some embodiments of the present disclosure;

FIG. 7 is a flow diagram of one operation of the tracking method in accordance with some embodiments of the present disclosure;

FIG. 8 is a flow diagram of the tracking method in accordance with some embodiments of the present disclosure and

FIG. 9 is a flow diagram of the tracking method in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

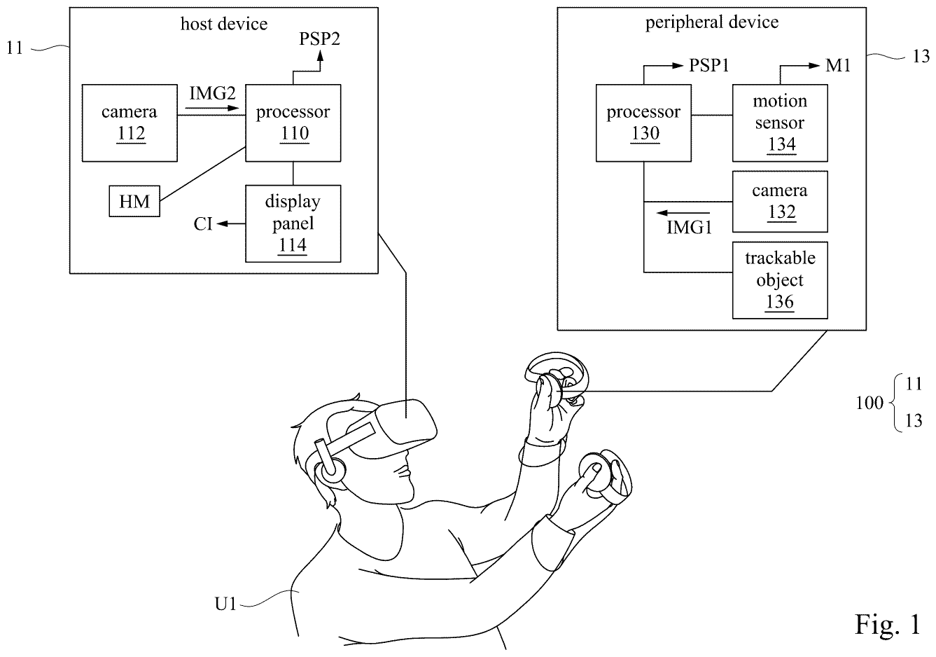

Referring to FIG. 1, FIG. 1 is a schematic diagram of a multi-device system 100 in accordance with some embodiments of the present disclosure. In some embodiments, the multi-device system 100 can be operated by a user U1 in a physical environment (e.g., a gaming place, a workplace, a house, etc.), and can provides an immersive experience for the user U1.

In some embodiments, as shown in FIG. 1, the multi-device system 100 includes a host device 11 and at least one peripheral device 13. In some practical applications, the host device 11 can be implemented with a wearable display device (e.g., a head-mounted device (HMD)) of an immersive system, and the peripheral device 13 can be implemented with a controller device (e.g., a handheld controller, a wearable controller, etc.) of the immersive system.

In some embodiments, the host device 11 is configured to localize both itself and the peripheral device 13 in the physical environment, and is configured to provide a visual feedback for the user U1 based on the localizations of the host device 11 and the peripheral device 13. Accordingly, as shown in FIG. 1, the host device 11 includes a processor 110, a camera 112 and a display panel 114. The processor 110 is electrically and/or communicatively coupled to the camera 112 and the display panel 114.

In the above embodiments of the host device 11, the camera 112 is configured to capture multiple host-based images in the physical environment. It should be understood that these host-based images may include at least one of images of the whole or partial physical environment, images of the peripheral device 13 and images of the user U1. The processor 110 is configured to use some feature extraction based localization technologies (e.g., Simultaneous Localization and Mapping (SLAM)) to calculate the position and/or orientation of the host device 11 according to the host-based images captured by the camera 112. The processor 110 is configured to use some interaction-based tracking technologies (e.g., optical tracking) to calculate the position and/or orientation of the peripheral device 13. Also, the processor 110 is configured to generate at least one visual content according to the positions and/or orientations of the host device 11 and the peripheral device 13. The display panel 114 is configured to display the at least one visual content generated by the processor 110, so as to provide an immersive content CI (i.e., the visual feedback) for the user U1.

In some embodiments, the host device 11 may occlude the direct visibility of the user U1 to the physical environment. In this case, the immersive content CI can be a virtual reality (VR) environment, or a mixed reality (MR) environment. In particular, the virtual reality environment may include at least one virtual reality object, which cannot be directly seen in the physical environment by the user U1. The mixed reality environment simulates the physical environment and enables an interaction of the at least one virtual reality object with a simulated physical environment. However, the present disclosure is not limited herein. For example, the immersive content CI can be the simulated physical environment without the virtual reality objects, which is known as a pass-through view.

In some embodiments, the host device 11 does not occlude the direct visibility of the user U1 to the physical environment. In this case, the immersive content CI can be an augmented reality (AR) environment. In particular, the augmented reality environment augments the physical environment directly seen by the user U1 with the at least one virtual reality object.

In some embodiments, the peripheral device 13 is configured to localize itself in the physical environment, and is configured to interact with the host device 11 to facilitate the localization of the peripheral device 13 performed by the host device 11. Accordingly, as shown in FIG. 1, the peripheral device 13 includes a processor 130, a camera 132, a motion sensor 134 and at least one trackable object 136. The processor 130 is electrically and/or communicatively coupled to the camera 132, the motion sensor 134 and the trackable object 136. In particular, the trackable object 136 is arranged on the exterior surfaces of the peripheral device 13 to be directly seen by the user U1 or be directly captured by the camera 112 of the host device 11. Moreover, in accordance with the above embodiments that the immersive content CI is the virtual reality environment, the mixed reality environment or the augmented reality environment, the user U1 can control the at least one virtual reality object in the immersive content CI with the peripheral device 13.

In the above embodiments of the peripheral device 13, the camera 132 is configured to capture multiple peripheral-based images in the physical environment. It should be understood that these peripheral-based images may include at least one of images of the whole or partial physical environment, images of the host device 11 and images of the user U1. The motion sensor 134 is configured to sense the movement of the peripheral device 13 to generate motion data M1. The processor 130 is configured to use some feature extraction based localization technologies (e.g., SLAM) to calculate the position and/or orientation of the peripheral device 13 according to the peripheral-based images captured by the camera 132. The processor 130 is configured to use some mathematical calculations to calculate the position and/or orientation of the peripheral device 13 according to the motion data M1 generated by the motion sensor 134. Also, the processor 130 is configured to actuate the trackable object 136 to allow the peripheral device 13 to interact with the host device 11. For example, when the trackable object 136 is actuated, the processor 110 of the host device 11 can recognize images of the trackable object 136 arranged on the peripheral device 13 from the host-based images captured by the camera 112 of the host device 11.

In the above embodiments, the processor 110 and the processor 130 each can be implemented with a central processing unit (CPU), a graphic processing unit (GPU), an application-specific integrated circuit (ASIC), a microprocessor, a system on a Chip (SoC) or other suitable processing circuits. The display panel 114 can be implemented with an active matrix organic light emitting diode (AMOLED) display, organic light emitting diode (OLED) display, or other suitable displays. The motion sensor 134 can be implemented with an inertial measurement unit (IMU) including an accelerometer, a gyroscope and a magnetometer, or other suitable sensors. The trackable object 136 can be implemented with an infrared light emitting diode (LED), or other suitable objects. In addition, the host device 11 and the peripheral device 13 each can further include a storage (e.g., a volatile memory, a non-volatile memory, etc.) and a communicator (e.g., a Wi-Fi module, a Bluetooth Low Energy (BLE) module, a Bluetooth module, etc.) to store signals, data and/or information and to communicate with each other or other devices (e.g., transferring signals, data and/or information). In some embodiment, the trackable object 136 may be the whole or partial physical shape of the peripheral device 13. That is, the shape of the peripheral device 13 may be pre-stored in the storage of the host device 11, so that the host device 11 may recognize the peripheral device 13 (the trackable object 136).

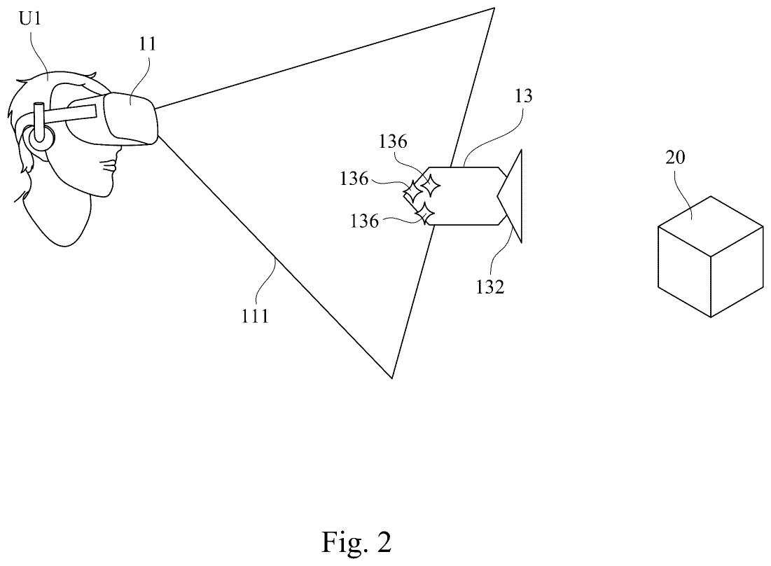

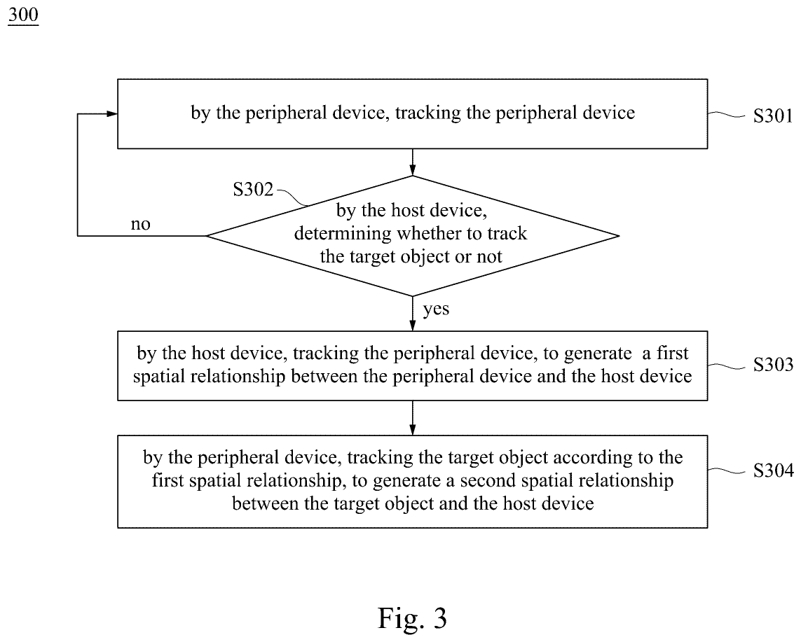

In the above embodiments, the processor 130 of the peripheral device 13 has a high computer performance, so that the peripheral device 13 is able to perform a self-tracking by the feature extraction based localization technologies. By the processor 130 with the high computer performance, the peripheral device 13 is also able to perform other applications, such as object tracking. However, the peripheral device 13 cannot perform both the self-tracking and the object tracking at the same time, which would limit the range of application of the multi-device system 100. Notably, the above limitation can be addressed by the multi-device system 100 performing a tracking method 300, which would be described in detail below with reference to FIGS. 2 and 3.

Referring to FIGS. 2 and 3 together, FIG. 2 is a schematic diagram of a scenario of the multi-device system 100 tracking a target object 20 in the physical environment in accordance with some embodiments of the present disclosure, and FIG. 3 is a flow diagram of the tracking method 300 in accordance with some embodiments of the present disclosure. In some embodiments, as shown in FIG. 3, the tracking method 300 includes operations S301-S304. However, the present disclosure should not be limited thereto.

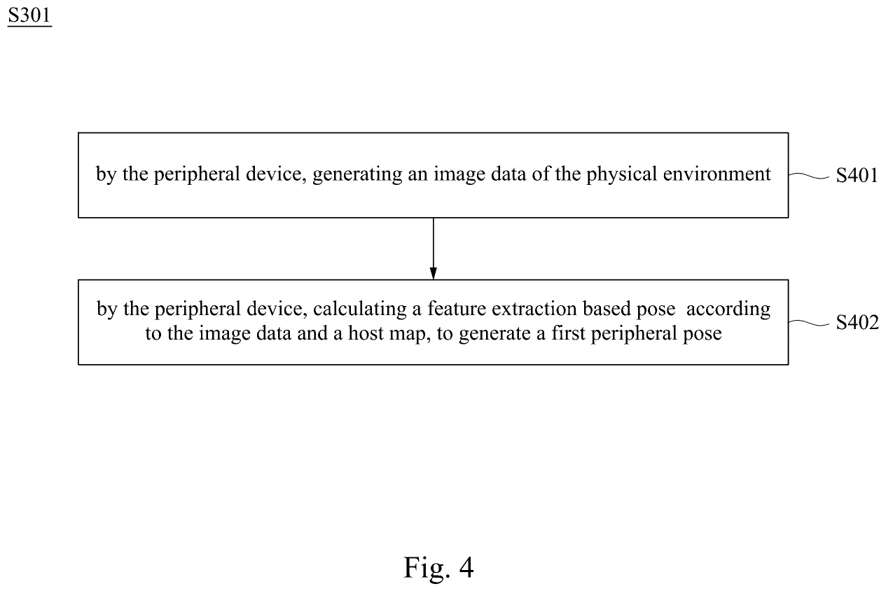

In operation S301, the peripheral device 13 tracks the peripheral device 13 (i.e., the self-tracking), which would be described in detail below with reference to FIGS. 1 and 4. FIG. 4 is a flow diagram of operation S301 in accordance with some embodiments of the present disclosure. In some embodiments, as shown in FIG. 4, operation S301 includes sub-operations S401-S402.

In sub-operation S401, the peripheral device 13 generates an image data IMG1 of the physical environment. In some embodiments, as shown in FIG. 1, the peripheral device 13 uses the camera 132 to capture the images of the whole or partial physical environment as the image data IMG1.

In sub-operation S402, the peripheral device 13 calculates a feature extraction based pose according to the image data IMG1 and a host map HM of the physical environment, to generate a first peripheral pose PSP1.

As shown in FIG. 1, the host map HM can be established by the host device 11 using the aforementioned host-based images captured by the camera 112. In particular, by the feature extraction based localization technologies, the processor 110 selects at least one image from the host-based images as at least one key frame, extracts multiple feature points from the at least one key frame, and uses these feature points as map points to generate the host map HM. Furthermore, the host map HM of the physical environment can be updated by the processor 110 each time one key frame is determined. For example, the processor 110 can add at least one new map point to the host map HM or can adjust the descriptor of at least one exist map point in the host map HM.

Before the sub-operation S402, the processor 130 can receive the image data IMG1 provided by the camera 132 and the host map HM transferred by the host device 11. In some embodiments of sub-operation S402, the processor 130 uses the feature extraction based localization technologies to calculate the feature extraction based pose. In particular, by the feature extraction based localization technologies, the processor 130 selects at least one image from the image data IMG1 as at least one key frame, extracts multiple feature points from the at least one key frame, and matches these feature points to the map points of the host map HM to determine the position and/or orientation of the peripheral device 13 in the host map HM (i.e., the position and/or orientation of the peripheral device 13 in the physical environment) as the feature extraction based pose. In some embodiments, the feature extraction based pose is directly used by the processor 130 as the first peripheral pose PSP1.

In some practical applications, the sampling frequency (e.g., 30 Hz) of the camera 132 is too low to satisfy some resolution requirements of the immersive system. In contrast, the sampling frequency (e.g., at least 100 Hz) of the motion sensor 134 is high enough for the resolution requirements of the immersive system. Accordingly, in some further embodiments of sub-operation S402, at each break in the image capture of the camera 132, the processor 130 performs the mathematical calculations on the motion data M1 generated by the motion sensor 134 to calculate the position and/or orientation of the peripheral device 13 in the physical environment as the first peripheral pose PSP1. In brief, the peripheral device 13 can generate the first peripheral pose PSP1 according to at least one of the motion data M1 and the feature extraction based pose to satisfy the resolution requirements of the immersive system.

In operation S302, the host device 11 determines whether to track the target object 20 or not. In some embodiments, the host device 11 is configured to receive a user input (not shown) which indicates an intention of the user U1 in tracking the target object 20. For example, the user input can be a voice command of the user U1, an operation that the user U1 operates the peripheral device 13 to input a specific command in the immersive content CI or click a specific virtual object in the immersive content CI, an operation that the user U1 clicks a specific physical button on the host device 11 and/or the peripheral device 13, etc. When the host device 11 receives the user input, the host device 11 determines to track the target object 20, so that operation S303 is performed. When the host device 11 does not receive the user input, the host device 11 determines not to track the target object 20, so that operation S301 is performed again.

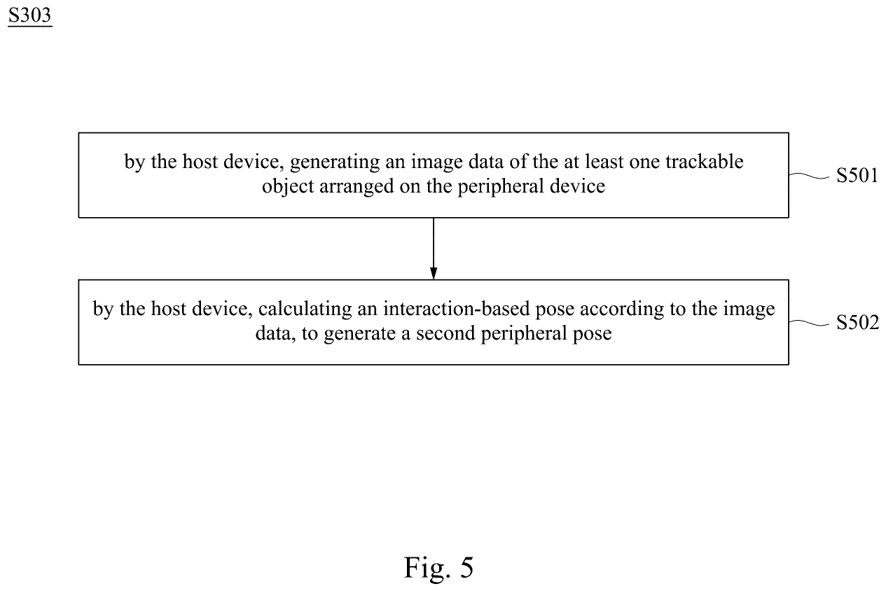

In operation S303, the host device 11 tracks the peripheral device 13, to generate a first spatial relationship between the peripheral device 13 and the host device 11, which would be described in detail below with reference to FIGS. 1 and 5. FIG. 5 is a flow diagram of operation S303 in accordance with some embodiments of the present disclosure. In some embodiments, as shown in FIG. 5, operation S303 includes sub-operations S501-S502.

In sub-operation S501, the host device 11 generates an image data IMG2 of the at least one trackable object 136 arranged on the peripheral device 13. In some embodiments, the trackable object 136 arranged on the peripheral device 13 is actuated. For example, the infrared light emitting diode, which is used to implement the trackable object 136, is controlled to emit the infrared light. Then, the host device 11 uses the camera 112 to capture the images of the trackable object 136 as the image data IMG2.

In sub-operation S502, the host device 11 calculates an interaction-based pose according to the image data IMG2, to generate a second peripheral pose PSP2. In some embodiments, as shown in FIG. 1, the processor 110 receives the image data IMG2 provided by the camera 112. The processor 110 may perform, for example triangulation, on the image data IMG2 to calculate the position and/or orientation of the trackable object 136 in the physical environment as the interaction-based pose. It should be understood that the interaction-based pose can be used to represent the position and/or orientation of the peripheral device 13 in the physical environment. In some embodiments, the interaction-based pose is directly used by the processor 110 as the second peripheral pose PSP2.

In accordance with the above descriptions of sub-operation S402, the sampling frequency (e.g., at least 100 Hz) of the motion sensor 134 is high enough for the resolution requirements of the immersive system in comparison with the sampling frequency (e.g., 30 Hz) of the camera 112. Accordingly, in some further embodiments of sub-operation S502, at each break in the image capture of the camera 112, the processor 110 performs some mathematical calculations on the motion data M1 generated by the motion sensor 134 to calculate the position and/or orientation of the peripheral device 13 in the physical environment as the second peripheral pose PSP2. In brief, the host device 11 can generate the second peripheral pose PSP2 according to at least one of the motion data M1 and the interaction-based pose to satisfy the resolution requirements of the immersive system. The second peripheral pose PSP2 generated by the host device 11 according to the at least one of the motion data M1 and the interaction-based pose indicates the position and/or orientation of the peripheral device 13 relative to the host device 11 (i.e., the first spatial relationship between the peripheral device 13 and the host device 11).

In the above embodiments, after the host device 11 determines to track the target object 20 in operation S302, the host device 11 can notify the peripheral device 13 of a start on tracking the target object 20. Accordingly, the peripheral device 13 stops performing the self-tracking, starts transferring the motion data M1 to the host device 11, and prepares for performing the object tracking (for example, setting an origin of coordinate (e.g., the first peripheral pose PSP1, the position and/or orientation of the camera 132, etc.) for tracking the target object 20). Thus, the host device 11 can use the motion data M1 to generate the second peripheral pose PSP2 in sub-operation S502.

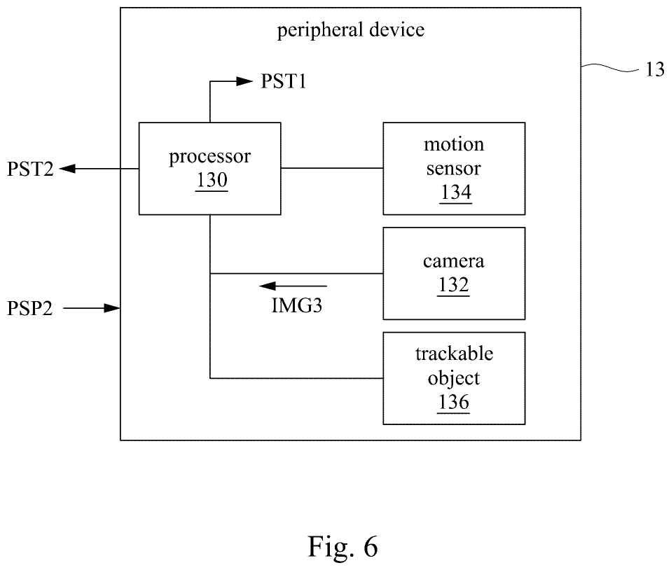

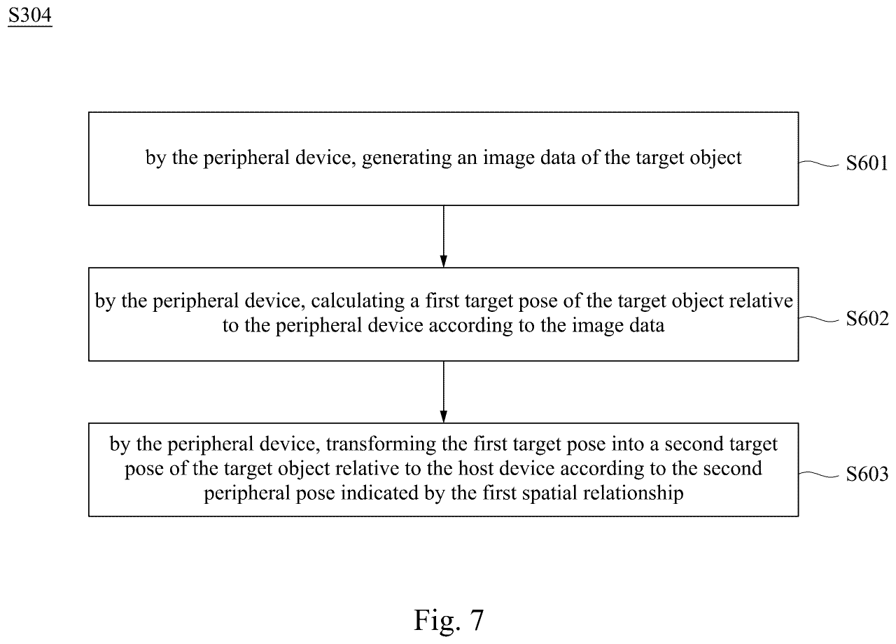

In operation S304, the peripheral device 13 tracks the target object 20 according to the first spatial relationship, to generate a second spatial relationship between the target object 20 and the host device 11, which would be described in detail below with reference to FIGS. 2, 6 and 7. FIG. 6 is a block diagram of the peripheral device 13 in accordance with some embodiments of the present disclosure. FIG. 7 is a flow diagram of operation S304 in accordance with some embodiments of the present disclosure. In some embodiments, as shown in FIG. 7, operation S304 includes sub-operations S601-S603.

In sub-operation S601, the peripheral device 13 generates an image data IMG3 of the target object 20. In the embodiments of FIGS. 2 and 6, the peripheral device 13 uses the camera 132 to capture images of the target object 20 as the image data IMG3.

In sub-operation S602, the peripheral device 13 calculates a first target pose PST1 of the target object 20 relative to the peripheral device 13 according to the image data IMG3 (i.e., the object tracking). In some embodiments, as shown in FIG. 6, the processor 130 receives the image data IMG3 provided by the camera 132. The processor 130 may use, for example outside-in tracking algorithms, to calculate the first target pose PST1 according to the image data IMG3. It should be understood that the first target pose PST1 can indicate the position and/or orientation of the target object 20 relative to the origin of coordinate (which can be regarded as the position and/or orientation of the target object 20 relative to the peripheral device 13).

In sub-operation S603, the peripheral device 13 transforms the first target pose PST1 into a second target pose PST2 of the target pose 20 relative to the host device 11 according to the second peripheral pose PSP2 indicated by the first spatial relationship. In some embodiments, as shown in FIG. 6, the peripheral device 13 receives the second peripheral pose PSP2 from the host device 11, so that the processor 130 would obtain the position and/or orientation of the peripheral device 13 relative to the host device 11. The processor 130 calculates a transformation data (not shown) by performing a transformation between the origin of coordinate setting for tracking the target object 20 and the position and/or orientation of the peripheral device 13 relative to the host device 11. For example, the processor 130 transforms the origin of coordinate into the second peripheral pose PSP2, so as to obtain data capable of making the position and/or orientation (or the six degrees-of-freedom (6-DOF)) of the origin of coordinate to have the position and/or orientation indicated by the second peripheral pose PSP2 as the transformation data.

In accordance with the above descriptions, the processor 130 uses the transformation data to transform the first target pose PST1 into the second target pose PST2. The second target pose PST2 indicates the position and/or orientation of the target object 20 relative to the host device 11 or in the host map HM of the physical environment (i.e., the second spatial relationship between the target object 20 and the host device 11). By the peripheral device 13 transferring the second target pose PST2 to the host device 11, the host device 11 can obtain the position and/or orientation of the target object 20 in the physical environment.

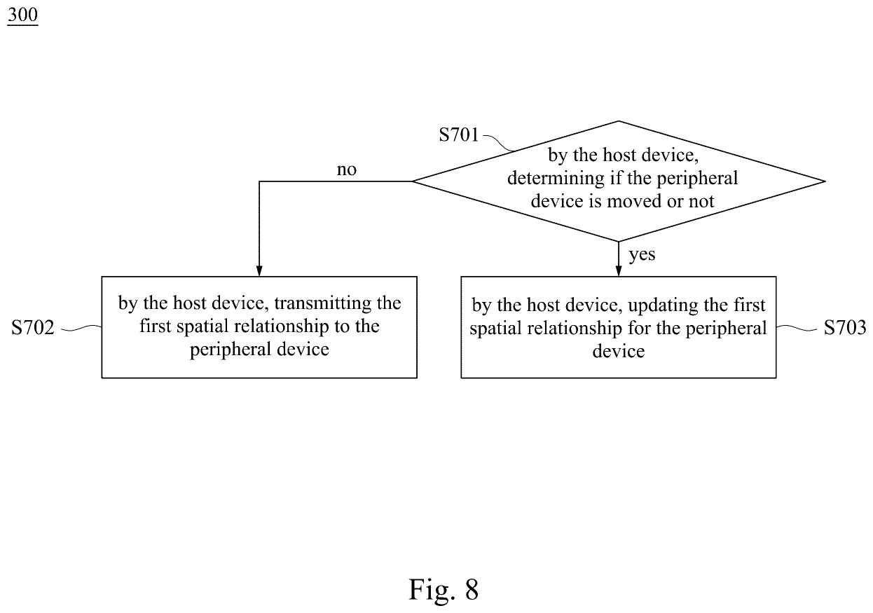

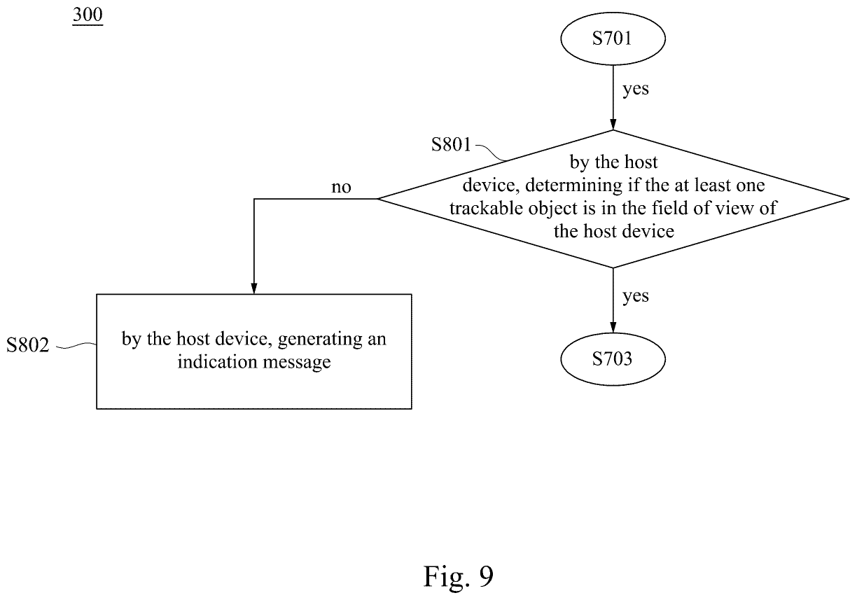

The tracking method 300 of the present disclosure is not limited to the embodiments of FIG. 3, which would be described in detail with reference to FIGS. 8 and 9. FIGS. 8 and 9 are flow diagrams of the tracking method 300 in accordance with some embodiments of the present disclosure.

In some embodiments, as shown in FIG. 8, the tracking method 300 further includes operations S701-S703. For example, operation S701 can be performed after operation S304.

In operation S701, the host device 11 determines if the peripheral device 13 is moved or not. In some embodiments, the processor 110 of the host device 11 determines if the peripheral device 13 is moved or not according to the motion data M1 received from the peripheral device 13. When the host device 11 determines the peripheral device 13 is not moved, operation S702 is performed. When the host device 11 determines the peripheral device 13 is moved, operation S703 is performed.

In some embodiments, because the peripheral device 13 is not moved, the peripheral device 13 can still generate the second spatial relationship between the target object 20 and the host device 11 through the same first spatial relationship that the peripheral device 13 uses in operation S304. Accordingly, in operation S702, the host device 11 transmits the first spatial relationship to the peripheral device 13.

As should be understood, because the peripheral device 13 is moved, if the peripheral device 13 still generates the second spatial relationship through the same first spatial relationship that the peripheral device 13 uses in operation S304, the second spatial relationship cannot be used to represent the actual position and/or orientation of the target object 20 relative to the host device 11. That is to say, there may be an error between the second target pose PST2 and the actual position and/or orientation of the target object 20 relative to the host device 11. Accordingly, in operation S703, the host device 11 updates the first spatial relationship for the peripheral device 13. In some embodiments, the host device 11 generates a new first spatial relationship between the peripheral device 13 and the host device 11 to update the first spatial relationship for the peripheral device 13, which can be referred to the descriptions of operation S303.

In some embodiments, as shown in FIG. 9, the tracking method 300 further includes operations S801-S802. For example, operation S801 can be performed after operation S701 and/or before operation S703.

As should be understood, the host device 11 requires the peripheral device 13 to be in the proximity of the host device 11 when using the interaction-based tracking technologies to generate the position and/or orientation of the peripheral device 13 relative to the host device 11 (i.e., the first spatial relationship). Therefore, in some embodiments, after the host device 11 determines the peripheral device 13 is moved in operation S701, the host device 11 determines if the at least one trackable object 136 is in the field of view 111 (as shown in FIG. 2) of the host device 11 in operation S801. When the host device 11 determines the at least one trackable object 136 is in the field of view 111, operation S703 is performed.

When the host device 11 determines the at least one trackable object 136 is not in the field of view 111, operation S802 is performed. In operation S802, the host device 11 generates an indication message. In particular, the indication message is configured to warn the user U1 that the user U1 should move the at least one trackable object 136 on peripheral device 13 to be in the field of view 111 of the host device 11. In some embodiments, the host device 11 can use the display panel 114 to display the indication message in the immersive content CI, or can use a speaker (not shown) of the host device 11 to play the indication message.

As can be seen from the above embodiments of the present disclosure, when the peripheral device 13 is switched from performing the self-tracking to performing the object tracking, the peripheral device 13 using the outside-in tracking algorithms can only provide the position and/or orientation of the target object 20 relative to the origin of coordinate set by the peripheral device 13. If the peripheral device 13 is moved, the position and/or orientation of the target object 20 relative to the origin of coordinate would be distorted because the peripheral device 13 using the outside-in tracking algorithms cannot update the origin of coordinate. Notably, by the host device 11 transferring the second peripheral pose PSP2 (i.e., the first spatial relationship) to the peripheral device 13, the peripheral device 13 can transform the position and/or orientation of the target object 20 relative to the peripheral device 13 to generate the position and/or orientation of the target object 20 relative to the host device 11. In such way, the multi-device system 100 can still provide the position and/or orientation of the target object 20 relative to the host device 11 when the peripheral device 13 is moved during the operation of the multi-device system 100, which expands the range of application of the multi-device system 100.

Furthermore, the second peripheral pose PSP2 (i.e., the first spatial relationship) generated by the host device 11 using the interaction-based tracking technologies and the first target pose PST1 generated by the peripheral device 13 by using the outside-in tracking algorithms are accurate. In such way, the second target pose PST2 generated by the peripheral device 13 according to the second peripheral pose PSP2 and the first target pose PST1 is also accurate. In sum of the above descriptions, the multi-device system 100 has advantages of large range of application, accurate tracking, etc.

The disclosed methods, may take the form of a program code (i.e., executable instructions) embodied in tangible media, such as floppy diskettes, CD-ROMS, hard drives, or any other transitory or non-transitory machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

1. A tracking method, applicable to a multi-device system, wherein the multi-device system is configured to track a target object in a physical environment and comprises a host device and a peripheral device, and the tracking method comprises:
by the peripheral device, tracking the peripheral device;
when the host device determines to track the target object, by the host device, tracking the peripheral device, to generate a first spatial relationship between the peripheral device and the host device; and
by the peripheral device, tracking the target object according to the first spatial relationship, to generate a second spatial relationship between the target object and the host device.

2. The tracking method of claim 1, wherein by the peripheral device, tracking the target object according to the first spatial relationship, to generate the second spatial relationship comprises:
by the peripheral device, generating an image data of the target object;
by the peripheral device, calculating a first target pose of the target object relative to the peripheral device according to the image data; and
by the peripheral device, transforming the first target pose into a second target pose of the target object relative to the host device according to a peripheral pose indicated by the first spatial relationship.

3. The tracking method of claim 1, wherein by the host device, tracking the peripheral device, to generate the first spatial relationship comprises:
by the host device, generating an image data of at least one trackable object arranged on the peripheral device; and
by the host device, calculating an interaction-based pose according to the image data, to generate a peripheral pose of the peripheral device relative to the host device.

4. The tracking method of claim 3, further comprising:
by the host device, receiving a motion data corresponding to a movement of the peripheral device, wherein the peripheral pose is generated according to at least one of the motion data and the interaction-based pose.

5. The tracking method of claim 1, wherein by the peripheral device, tracking the peripheral device comprises:
by the peripheral device, generating an image data of the physical environment; and
by the peripheral device, calculating a feature extraction based pose according to the image data and a host map established by the host device, to generate a peripheral pose of the peripheral device.

6. The tracking method of claim 5, further comprising:
by the peripheral device, generating a motion data corresponding to a movement of the peripheral device, wherein the peripheral pose is generated according to at least one of the motion data and the feature extraction based pose.

7. The tracking method of claim 1, further comprising:
when the host device determines that the peripheral device is not moved, by the host device, transmitting the first spatial relationship to the peripheral device.

8. The tracking method of claim 1, further comprising:
when the host device determines that the peripheral device is moved, by the host device, updating the first spatial relationship for the peripheral device.

9. The tracking method of claim 8, wherein after the host device determines that the peripheral device is moved, the tracking method further comprises:
when the host device determines that at least one trackable object is not in a field of view of the host device, by the host device, generating an indication message.

10. The tracking method of claim 8, wherein before updating the first spatial relationship for the peripheral device, the tracking method further comprises:
by the host device, determining at least one trackable object is in a field of view of the host device.

11. A multi-device system, configured to track a target object in a physical environment, and comprising:
a host device, configured to determine whether to track the target object or not; and
a peripheral device, configured to track the peripheral device,
wherein the host device is configured to track the peripheral device when the host device determines to track the target object, to generate a first spatial relationship between the peripheral device and the host device, and
wherein the peripheral device is configured to track the target object according to the first spatial relationship when the host device determines to track the target object, to generate a second spatial relationship between the target object and the host device.

12. The multi-device system of claim 11, wherein the peripheral device is configured to generate an image data of the target object, is configured to calculate a first target pose of the target object relative to the peripheral device according to the image data, and is configured to transform the first target pose into a second target pose of the target object relative to the host device according to a peripheral pose indicated by the first spatial relationship.

13. The multi-device system of claim 11, wherein the host device is configured to generate an image data of at least one trackable object arranged on the peripheral device, and is configured to calculate an interaction-based pose according to the image data, to generate a peripheral pose of the peripheral device relative to the host device.

14. The multi-device system of claim 13, wherein the host device is further configured to receive a motion data corresponding to a movement of the peripheral device, wherein the peripheral pose is generated according to at least one of the motion data and the interaction-based pose.

15. The multi-device system of claim 11, wherein the peripheral device is configured to generate an image data of the physical environment, and is configured to calculate a feature extraction based pose according to the image data and a host map established by the host device, to generate a peripheral pose of the peripheral device.

16. The multi-device system of claim 15, wherein the peripheral device is further configured to generate a motion data corresponding to a movement of the peripheral device, wherein the peripheral pose is generated according to at least one of the motion data and the feature extraction based pose.

17. The multi-device system of claim 11, wherein the host device is further configured to transmit the first spatial relationship to the peripheral device when the host device determines that the peripheral device is not moved.

18. The multi-device system of claim 11, wherein the host device is further configured to update the first spatial relationship for the peripheral device when the host device determines that the peripheral device is moved.

19. The multi-device system of claim 18, wherein after the host device determines that the peripheral device is moved, the host device is configured to generate an indication message when the host device determines that at least one trackable object is not in a field of view of the host device.

20. A non-transitory computer readable storage medium with a computer program to execute a tracking method applicable to a multi-device system, wherein the multi-device system is configured to track a target object in a physical environment and comprises a host device and a peripheral device, and the tracking method comprises:
by the peripheral device, tracking the peripheral device;
when the host device determines to track the target object, by the host device, tracking the peripheral device, to generate a first spatial relationship between the peripheral device and the host device; and
by the peripheral device, tracking the target object according to the first spatial relationship, to generate a second spatial relationship between the target object and the host device.
